(19) United States
(12) Patent Application Publication
(10) Pub. No.: US 2009/0066466 A1
(43) Pub. Date: Mar. 12, 2009

(54) Coil System Comprising Eccentrically Coiled Magnetic Substance

(76) Inventor: Kunitaka Arimura, Kanagawa (JP)

Correspondence Address: JAMES C. WRAY, 1493 CHAIN BRIDGE ROAD, SUITE 300, MCLEAN, VA, 22101, US

(21) Appl. No.: 12/224,583

(22) PCT Filed: Mar. 2, 2007
(86) PCT No.: PCT/JP2007/054036

§ 371 Date: Aug. 29, 2008

(30) Foreign Application Priority Data
Mar. 2, 2006 (JP) 2006-001458

(51) Int. Cl. H01F 17/04; H01F 27/245

(52) U.S. Cl. 336/221; 336/212

(57) ABSTRACT

The present invention provides a coil system comprising an eccentrically coiled magnetic substance capable of exciting vertical magnetic field components in its center portion and preventing sensitivity of the coil system deteriorating in its center. In the coil system comprising a magnetic substance 6 and a coil 2, no coil is wound around a center portion of the magnetic substance 6, but a coil is wound around one end portion of the magnetic substance. When the coil system is mounted on a metal surface, it can excites vertical magnetic field components to the metal surface without deteriorating sensitivity in the center of a tag or sensor arranged above the coil system.

### FIELD OF THE INVENTION

The present invention relates to a coil system comprising an eccentrically coiled magnetic substance, which can be applied to a metal surface and can excite vertical magnetic components perpendicular to its axis so as to be employed by an RFID tag or a sensor.

### RELATED BACKGROUND ART

Since a non-contact type IC card and an RFID tag having a coil therein as well as a sensor for a reader/writer used together with the IC card and the RFID tag are actuated in a magnetic field or an electric field generated by a high frequency vibration, their sensitivities are greatly deteriorated due to a mirror effect which offsets the magnetic field or the electric field, if such sensors are placed closely to a metal body or metal surface.

There is a structure called “on metal”, where a magnetic sheet is inserted between a coil of the RFID and the metal surface in order to prevent the sensitivities from being deteriorated. Although this structure is effective to a certain extent, merely a portion of magnetic field directs to a vertical direction to the metal surface, since the magnetic field is influenced by the metal surface and since magnetic field components parallel to and near the metal surface are compensated each other.

A patent application (reference 1) proposes a method to increase sensitivity by 6 dB by utilizing the mirror effect effectively as arranging a square coil lateral to a metal surface.

This method is one of effective technology by utilizing the metal surface, but it has a problem.

Because usually a square shaped coil is employed in a card or sensor, insensitive areas are generated in a central part of the card or sensor when the method disclosed in reference 1 is employed.

Reference 1: Japanese laid open patent No. 2003-317052

### DISCLOSURE OF THE INVENTION

### Problems to be Solved by the Invention

The objective of the present invention is to provide a coil system capable of exciting magnetic components vertical a metal surface by utilizing the effect of the metal surface, so that sensitivity in the center part of the sensor or tag is prevented from deteriorating. Since the vertical magnetic field components are excited even in the center, the sensitivity is kept from deteriorating.

The present invention is carried out in view of the above-mentioned objective in order to provide the coil system comprising the eccentrically coiled magnetic substance.

### Means to Solve the Problem

In order to solve the problems mentioned above, the coil system by the present invention is constituted as one of the following arrangements from (1) to (8).

(1) A coil system comprising an eccentrically coiled magnetic substance, wherein: no coil is wound around a center portion of the magnetic substance, but a coil is wound around one end portion of the magnetic substance.

(2) The coil system according to (1), wherein: the magnetic substance has a rectangular shape.

(3) The coil system according to (1), wherein: the magnetic substance has a flat shape.

(4) The coil system according to (1), wherein: the center portion of the magnetic substance where no coil is wound around has a certain size.

(5) The coil system according to (1), wherein: the center portion of the magnetic substance where no coil is wound around, mainly has a communicating function by utilizing vertical magnetic field components excited therein.

(6) The coil system according to (1), wherein: a metal surface is arranged on one side of the magnetic substance.

(7) The coil system according to (1), wherein: the magnetic substance consists of thin plates.

(8) A sensor system comprising the coil system according to one of (1) to (7), wherein: the coil system is covered by a plastic cover and directly fitted to a metal plate.

### EFFECTS ATTAINED BY THE INVENTION

The coil system by the present invention can not only prevent its sensitivity from deteriorating, when a tag or sensor, which captures vertical magnetic field components, is arranged on the metal surface, but also prevent sensitivity in the center of the tag or sensor from deteriorating as well as prevent the insensitive areas in the center.

As described in reference 1, although the effect of the metal surface is eliminated and the sensitivity is enhanced, vertical magnetic field components are evenly excited at both poles of the magnetic substance. But, only horizontal magnetic field components are excited and no vertical magnetic field components are excited in the center of the magnetic substance. Therefore, if a card or tag sensor is placed above the center of the magnetic substance, no voltages or electric currents are induced in the card or tag sensor.

In order to solve such problem, “a sensor system capable of exciting vertical magnetic field components” is proposed by the inventor of the present invention (filed a patent application, but not disclosed yet), this sensor system is not suitable for some applications, since the system has the protrusion so that it is rather thick.

This sensor system can easily excite vertical magnetic field components, but this sensor system has to secure a long magnetic path at the end of the coil in order to excite vertical magnetic field components more by the electric current flowing in the coil.

However, the coil system by present invention can provide unevenly distributed magnetic field components, so that no insensitive areas are generated above the coil system. Therefore it is favorable to employ the coil system by the present invention as a sensor as well as a tag, since vertical magnetic field components are excited and no insensitive areas are formed in the center area of the sensor or the tag. As a result the present invention succeeds in providing a stable sensor system or tag system.

### BRIEF DESCRIPTIONS OF THE DRAWINGS

FIG. 1 is a schematic view for explaining an operational principle of the present invention.

FIG. 2 is a side view of another example of the coil systems comprising the eccentrically coiled magnetic substance is set narrower compared with the conventional coil system shown in FIG. 9.

FIG. 3 is a side view of one example of the coil systems where a coil is wound around one end of a magnetic substance.

FIG. 4 is a perspective view illustrating an example of the coil systems configured as a tag system.

FIG. 5 is a perspective view illustrating the coil system employed in a sensor system.

FIG. 6 is a perspective view illustrating the coil system applied to a tag system.

FIG. 7 shows a sensor system where the coil system is integrated and mounted on a print circuit board. (a) is plan view, (b) is a side view and (c) is a side view of the integrated sensor system.

FIG. 8 is cross-sectional views illustrating the coil system applied to bent metal surface.

FIG. 9 is a perspective view illustrating a conventional sensor or tag.

### PREFERRED EMBODIMENTS BY THE PRESENT INVENTION

Hereinafter, the preferred embodiments by the present invention are explained in details.

### Embodiment

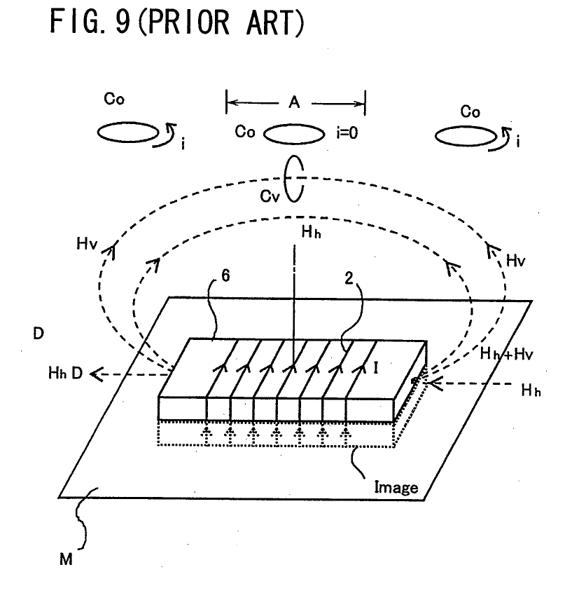

FIG. 9 is the perspective view illustrating an example of the conventional sensors or tags.

A coil 2 is wound around a square magnetic substance 6. A magnetic field H (Hh, Hv) is excited by a current I flowing in the coil 2. Magnetic field components excited at two poles or both ends of the coil extend in a parallel or oblique direction and a part of them extend in a vertical direction. At both ends of the magnetic substance, horizontal magnetic field components Hh and vertical magnetic field components Hv co-exist. If external coils Co are arranged around both ends of the magnetic substance, electromotive force is generated in the coils Co so that an electric current i flows in the external coils Co as illustrated in FIG. 9.

As described in reference 1, a magnetic flux is doubled (6 dB) on a metal face M due to an image downward of the metal surface generated by the mirror effect. This is an advantageous feature of the present conventional example. However, no electric current flows in a horizontal coil Co arranged in the middle (area A) of the coil system, since only the horizontal magnetic field components extends in parallel direction to metal surface. On the other hand, a vertical coil Cv can capture the horizontal magnetic field components. If the present conventional coil system is applied to a tag or sensor system, an insensitive area exists in the middle area of the coil system, so that the present conventional coil system is not appropriate for applying to sensor or tag systems.

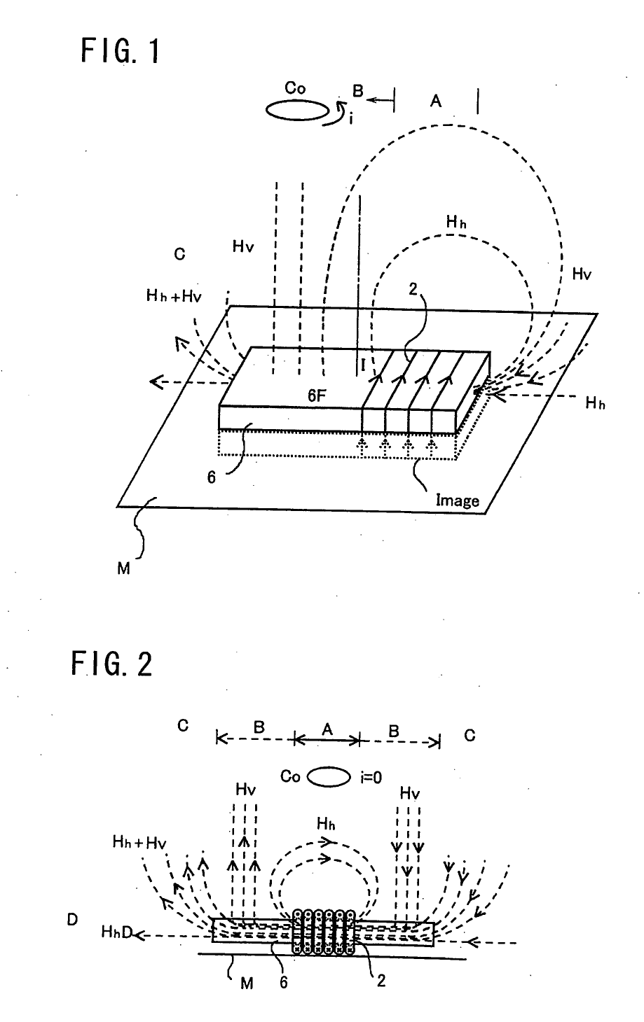

FIG. 1 is the schematic view for explaining the operational principle of the present invention.

Compared with FIG. 9, it is obvious that a coil 2 is wound around a left portion of a magnetic substance 6, so that vertical magnetic field components are excited in a center portion of the coil system, which is suitable for sensor or tag systems. In the present case, horizontal magnetic field components Hh and vertical magnetic field components Hv co-exist at both ends of the coil system. Since the present coil system can secure a wide magnetic substance surface 6F, it can easily obtain horizontal magnetic field components Hv. In other words, in area B an electric current i can be induced in a horizontal coil Co. The size of the magnetic substance surface 6F is appropriately determined depending on a thickness, magnetic permeability of the magnetic substance, turning number of the coil, a frequency of the applied electric current and the like.

In this manner, since the vertical magnetic field components can be excited in the center area of the magnetic substance and since the center area can be secured wide, the present coil system is favorable for being employed as sensors or tags. Further, since the metal surface is employed in the present magnetic system, sensitivity is increased by 6 dB compared with a coil system without the metal surface.

FIG. 2 is the side view of another example of the coil systems, where a coil wound area of the magnetic substance is set narrower compared with the conventional coil system shown in FIG. 9. In FIG. 2, the coil 2 is illustrated exaggeratedly thick, but actually there is hardly any gap between the magnetic substance 6 and the metal surface M.

An area A, where the horizontal magnetic field components Hh are dominant, is formed in the upper area of the coil 2. Two areas B, where the vertical magnetic field components are dominant, are formed adjacent to both side of the area A. Further two areas C, where the horizontal magnetic field components Hh and the vertical magnetic field components Hv co-exist, are formed outside of the respective areas B.

At the end of the magnetic substance, an area D, where horizontal magnetic field components HhD extend parallel to the metal surface M. This horizontal magnetic field components HhD are most intensive.

Vertical magnetic field components Hv extending between the area B and the area C are also enhanced by the mirror effect due to the metal surface M, so that intensive magnetic field components can be obtained.

Since the present coil system is symmetrical and the area A where no electric current is induced in the horizontal coil Co, the coil Co should be displaced in either direction right or left in order to induce the electric current in the coil Co.

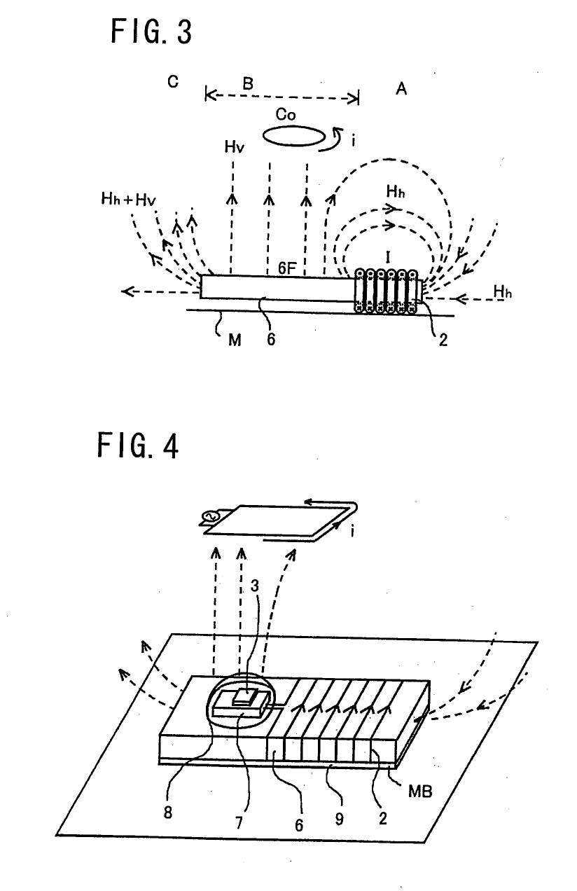

FIG. 3 is a configuration to displace the area A aside. In the present embodiment, since the coil 2 is wound around one end of the magnetic substance 6, the area B is formed above the center part of coil system where the magnetic substance 6 is not wound by the coil 6, only the vertical magnetic field components exist. Since the area A does not exist in the center part of the coil system, it is not confusing to operate a card system by moving above the coil system when the present coil system is applied to the card system.

When the coil system is applied to a tag system and the coil Co is arranged above a center part of the tag system, the insensitive area A can be avoided in this arrangement.

FIG. 4 shows one example of the coil system configured as the tag system.

In the present tag system, the coil 2 is wound around one end of the magnetic substance 6. A metal plate MB is arranged under the coil 2. (Even if the metal plate can be arranged between the coil 2 and the magnetic substance 6, it is effective to deviate inductance.) Both ends of the coil are bonded with electrodes 7 placed on an insulating film. An IC 3 is bonded to the electrodes 7 by a flip chip method or a wire bonding method. In order to resonate the tag system, an inductance L of the coil system and a capacitance C of the IC are determined according to the following equation:

2πf=1/√(LC).

For example, if the capacitance is 22 PF and the inductance is 6.3 μH, a resonating frequency is calculated as 13.56 MHz.

In order to protect the tag system, the IC and bonded portions are protected by a potting 8, after the IC is mounted and connected to the electrodes by the flip chip method or the wire bonding method.

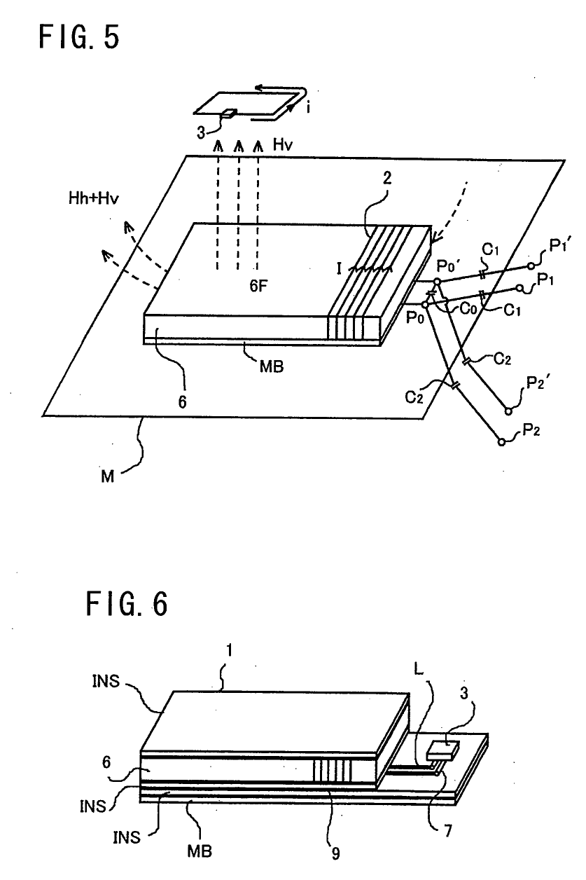

FIG. 5 is the perspective view illustrating the coil system employed in the sensor system.

The vertical magnetic field components Hv are excited on the magnetic substance surface 6F by an electric current I flowing in the coil 2 wound around a right end portion of the magnetic substance 6.

The metal plate MB is stuck to a metal surface M side of the magnetic substance 6.

Both ends of the coil 2 are connected to terminals Po, Po′. In order to resonate, parallel capacitors C₂ are respectively connected to the terminals Po, Po′.

Since the coil 2 has functions to transmit and to receive signals, for example, if a terminal P₁ is set as an inputting terminal, namely as a transmitting terminal, a terminal P₂ is set as an outputting terminal, namely as a receiving terminal. Both terminals are respectively separated by capacitors C₁ and C₂.

An electric current i induced by the vertical magnetic field components Hv, flows in a coil of a tag or card arranged above the coil system, so that power is supplied to the IC 3 connected to the coil of the tag or card.

FIG. 6 is the perspective view illustrating the coil system applied to the tag system.

The magnetic substance 6 forms a layered structure together with non-magnetic dielectric layer. A coil is printed on the layered structure functioning as a core. The coiled layered structure is sandwiched by non-magnetic insulating layers INS. Both ends of the coil are connected by terminals 7 via lead wires L, which are connected to the terminals 7 by through holes.

The IC 3 is bonded to the terminals 7 by the bonding method or the flip chip method. It is favorable to protect the IC and boded portions by the potting as shown in FIG. 4.

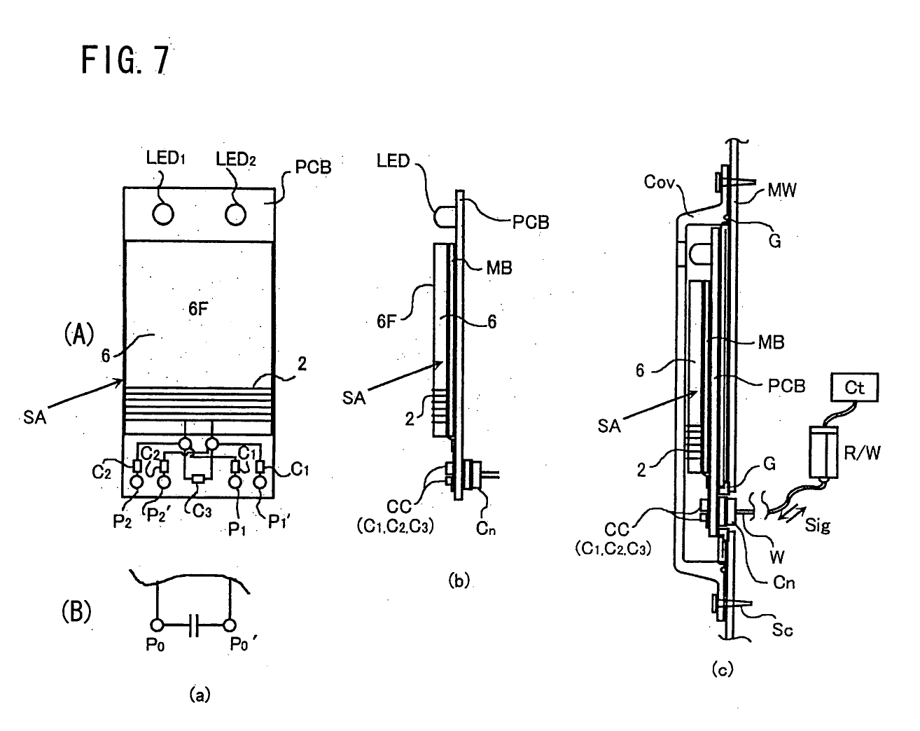

FIG. 7 shows the sensor system where the coil system is integrated and mounted on a print circuit board.

FIG. 7 (a) is a plan view of a flexible or thin printed circuit board on which the magnetic substance configured as shown in FIG. 5 and LEDs are mounted, so that a sensor antenna SA is constituted. Usually a red LED and a green LED and a combination of these LED are employed. Sometimes an orange or yellow LED is added to the combination. A circuit diagram shown in (A) of FIG. 7 (a) is configured to connect four wires to a transceiver by leading inputting and outputting wires separately. A circuit diagram shown in (B) of FIG. 7 (a) is configured to connect two wires to the transceiver, and transmitting signals and receiving signals are separated by a circuit in the transceiver.

FIG. 7 (b) is a side view of the sensor antenna SA shown in FIG. 7 (a). As shown in FIG. 7 (b), the magnetic substance 6 and the circuit board PCB are integrated, both ends of the coil 2 are connected to lead wires of the circuit board, and capacitors C₁, C₂ and C₃ are connected to the lead wires. At the back of the circuit board, a connector Cn is mounted for supplying power to the circuit board. The coil is wound around the magnetic substance 6 so as to traverse a longitudinal direction, but the coil can be wound around parallel to the longitudinal direction.

FIG. 7 (c) is a side view of an integrated sensor system where the sensor antenna SA is accommodated in a plastic case Cov, and the plastic case accommodating sensor antenna is fitted to an iron wall MW by screws Sc. A hole with a diameter of from 5 to 10 mm is formed on the iron wall MW for leading the wiring. If a bushing (or a gasket) is fitted to the hole for the wiring and fitted to contacting areas between the plastic case Cov and the iron wall MW, the integrated sensor system is constituted as a water-proof sensor system.

The antenna is not be affected by the metal surface or the iron wall, but its sensitivity is enhanced by utilizing the mirror effect of the iron wall. Since the antenna sensor is directly fitted to the metal surface or the iron wall separated from a transceiver, it is not necessary to form a window larger than the antenna sensor on the iron wall in order to divert magnetic field components as did in conventional antennas. As a result, the integrated sensor system by the present invention does not harm walls of buildings and does not cause water leakages. The integrated sensor system is used for access controls. Since the thin sensor antenna can be fitted directly to the metal surface and no window for diverting magnetic field components is required. As a result since the sensor system requires no considerable fabrication for fitting, no water leakages are caused and the sensor system has a sufficient strength, so that the sensor or the sensor antenna SA can be employed in automatic vendor machines, POS terminals, wickets and other terminals. If the antenna sensor by the present invention is fitted to outside of the metal surface and the transceiver is arranged inside of the metal surface, the transceiver is protected and shielded by the metal surface. Consequently a more convenient sensor system is obtained.

The integrated sensor system is connected to the transceiver via wiring W connected to the connector Cn.

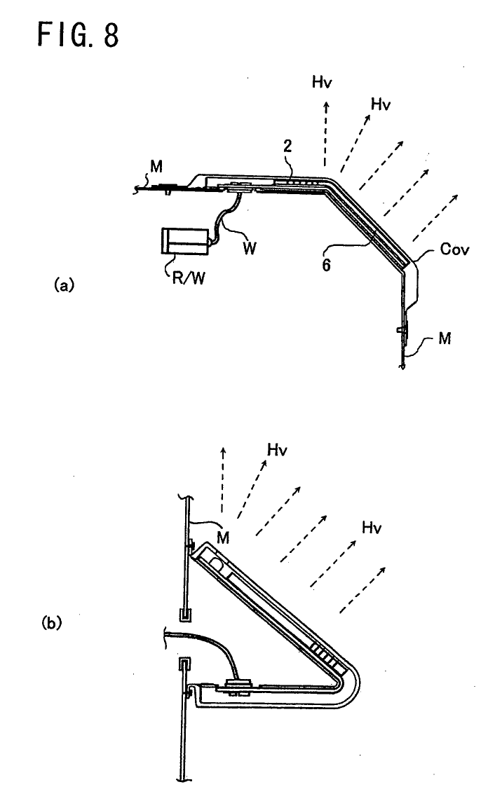

FIG. 8 is cross-sectional views illustrating the coil system applied to bent metal surface.

In the present embodiment, since the magnetic substance must be bent beforehand in order to fit to the bent metal surface, such magnetic substance can be formed by sintering molded magnetic powder or flexible magnetic rubber sheet. Since magnetic field components can be diverted outward at the bent portion, a response of the sensor system to the external tag or card is improved.

As described above, since the coil system comprising the eccentrically coiled magnetic substance by the present invention can be applied to the tag or the sensor effectively, the conventional problems can be solved effectively by a simple method, so that the coil system by the present invention has a large practical effectiveness.

### Resume of the Invention

Since the insensitive area above the coil system is avoided and the wider area for exciting vertical magnetic field components can be secured by the coil system comprising the eccentrically coiled magnetic substance, where the coil is wound around one end of the magnetic substance, so that the present invention can attain two effects with one coil system. Although the coil system itself is thin, it is very useful for constituting highly sensitive tags or sensor antennas by utilizing the mirror effect of the metal surface.

1. A coil system comprising an eccentrically coiled magnetic substance, wherein:
a coil is wound around said magnetic substance without being wound around a center portion of said magnetic substance, and
said coil is wound around one end portion of said magnetic substance, in order that more vertical magnetic field components are obtained in the center portion of said magnetic substance by utilizing magnetic field components extending from other end portion in a direction vertical to an axial direction of said coil together with vertical magnetic field components excited in the center portion.

2. The coil system according to claim 1, wherein:
said magnetic substance has a rectangular shape.

3. The coil system according to claim 1, wherein:
said magnetic substance has a flat shape.

4. The coil system according to claim 1, wherein:
the center portion of said magnetic substance where no coil is wound around has a certain size.

5. The coil system according to claim 1, wherein:
the center portion of said magnetic substance where no coil is wound around, mainly has a communicating function by utilizing vertical magnetic field components excited therein.

6. The coil system according to claim 1, wherein:
a metal surface is arranged on one side of said magnetic substance.

7. The coil system according to claim 1, wherein:
said magnetic substance consists of thin plates.

8. A sensor system comprising the coil system according to claim 1, wherein:
said coil system is covered by a plastic cover and directly fitted to a metal plate.
